(19) United States
(12) Patent Application Publication
(10) Pub. No.: US 2011/0052356 A1
(43) Pub. Date: Mar. 3, 2011

(54) Multidimensional Lifting Handtruck

(75) Inventors: John M. Leatherman, Ijamsville, MD (US); Scott H. Kunkel, Haymarket, VA (US)

(73) Assignee: Raytheon Company, Waltham, MA (US)

(21) Appl. No.: 12/550,778

(22) Filed: Aug. 31, 2009

(51) Int. Cl. B62B 1/14; B62B 1/00

(52) U.S. Cl. 414/444; 280/47.33

(57) ABSTRACT

According to one embodiment, a handtruck is provided. The handtruck may have wheels. Legs, approximately parallel to the ground, are coupled to the wheels. The legs may also be moved within a plane that is approximately parallel to the ground. A back is coupled approximately perpendicular to the legs. A payload coupler is coupled to the back and allows the coupling of a payload to the handtruck.

### TECHNICAL FIELD OF THE INVENTION

This invention relates to devices that assist a user in moving materials, and more particularly to a multidimensional lifting handtruck.

### BACKGROUND OF THE INVENTION

Handtrucks are often used to move light objects from one location to another. Often the objects are placed on the legs of the handtruck and the handtruck is tilted slightly backwards to allow smooth rolling of the wheels across a surface.

### SUMMARY OF THE INVENTION

According to one embodiment, a handtruck is provided. The handtruck may have wheels. Legs, approximately parallel to the ground, are coupled to the wheels. The legs may also be moved within a plane that is approximately parallel to the ground. A back is coupled approximately perpendicular to the legs. A payload coupler is coupled to the back and allows the coupling of a payload to the handtruck.

According to another embodiment, a handtruck with wheels is provided. Legs, approximately parallel to the ground, are coupled to the wheels. A back is coupled approximately perpendicular to the legs. A payload coupler is coupled to the back and allows the coupling of a payload to the handtruck. A lifting mechanism is provided to raise and lower the payload coupler along the back.

Technical advantages of certain embodiments of the present invention include the ability to move heavy payloads without the use of electricity. Other advantages may include providing a wide range of adjustability for the positioning of the payload on the handtruck. This may provide the ability for a single user to perform installation tasks in confined spaces or lifting and positioning of the payload that previously required two or more users. Other technical advantages of the present invention will be readily apparent to one skilled in the art from the following figures, descriptions, and claims. Additionally, while specific advantages have been enumerated above, various embodiments may include all, some, or none of the enumerated advantages. The following technical advantages may be achieved by some or all of the embodiments of the present invention.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a view of an embodiment of a multidimensional lifting handtruck;

FIG. 2 is a reverse view of the multidimensional lifting handtruck of FIG. 1;

FIG. 3 illustrates the attachment of a payload to the multidimensional lifting handtruck in a particular embodiment;

FIG. 4 illustrates certain degrees of movement of the multidimensional lifting handtruck;

FIG. 5 illustrates a backstop feature of particular embodiments of the multidimensional lifting handtruck;

FIG. 6 illustrates a tilting mechanism of particular embodiments of the multidimensional lifting handtruck.

### DETAILED DESCRIPTION OF THE INVENTION

It should be understood at the outset that although example implementations of embodiments of the invention are illustrated below, embodiments of present invention may be implemented using any number of techniques, whether currently known or in existence. The present invention should in no way be limited to the example implementations, drawings, and techniques illustrated below. Additionally, the drawings are not necessarily drawn to scale.

In an industrial environment, particularly with respect to electronic and mechanical equipment, equipment will need to be repaired or replaced. If the equipment is in a remote location, often a single operator is sent to remove and replace the equipment. The equipment is often heavy and bulky, which makes it difficult for one person to safely remove or replace. Additionally, the equipment may be located in a space where two people physically cannot be present. The transport of the equipment to and from the installation site may also be difficult for a single person to carry and/or support during the installation process. What is needed is a tool that can assist an installer in the transport and installation process of such equipment.

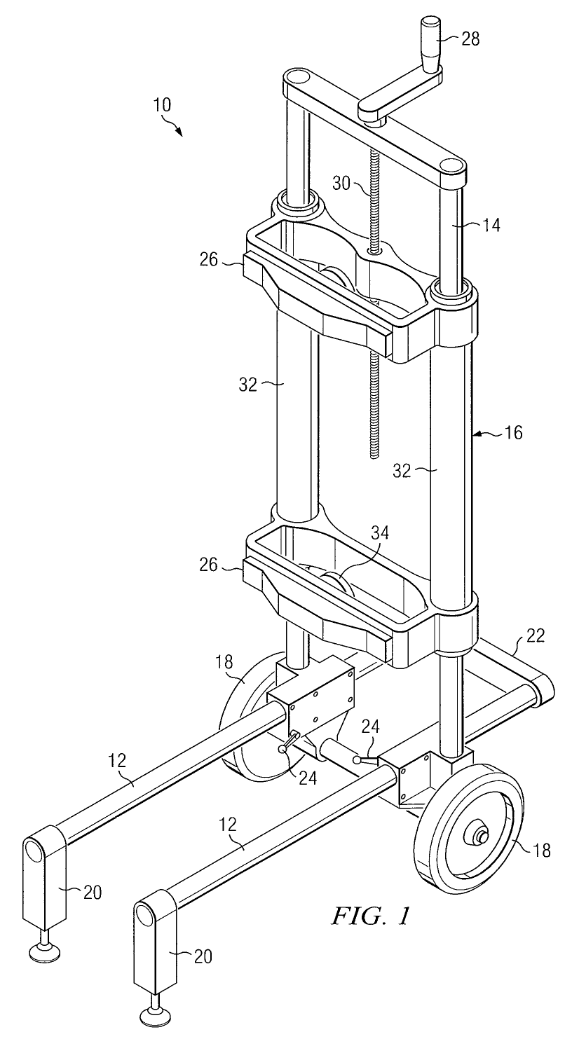

FIG. 1 is a view of an embodiment of a multidimensional lifting handtruck. In particular embodiments handtruck 10 may comprise legs 12, back 14 with payload lifter assembly 16. Legs 12 may be coupled to wheels 18, feet 20 and backstop 22. Backstop 22 may be on the opposite end of feet 20. Leg locker 24 may act as a locking mechanism for legs 12. Back 14, may be coupled approximately perpendicular to the plane of legs 12.

Coupled to back 14, payload lifter assembly 16 may comprise a payload coupler 26, crank 28, and screw 30. Additionally pipes 32 may be used as part of the mechanism to raise and lower the payload lifter assembly 16. Moreover, payload lifter assembly may be coupled to a payload tilter comprising a knob 34 and groove 36 (not illustrated in FIG. 1).

In particular embodiments, legs 12 may comprise two rods of any suitable material such as aluminum, steel, plastic, wood, and/or carbon fiber. Alternatively legs 12 may have more or less rods, be a solid or semi-solid sheet of material or of any other suitable shape. Legs 12 are positioned generally parallel to the ground when handtruck 10 is in an upright position.

Wheels 18 may be attached to legs 12. Wheels 18 may made of any suitable material and provide the ability to permit movement of the handtruck when tilted from the upright position. Wheels 18 may be made of any suitable material and should be capable of supporting the weight of the payload on handtruck 10.

Feet 20 may be attached at the one end of legs 12 or at other suitable areas of legs 12. Feet 20 may be attached in a plane generally perpendicular to the plane of legs 12. Feet 20 may be height adjustable by a user. Height adjustment of feet 20 may be accomplished using a rotational motion or other suitable methods. Together with wheels 18, feet 20 help to maintain legs 12 in a plane generally parallel to the ground when handtruck 10 is in an upright position.

Backstop 22 may be attached to the opposite end of feet 12. Backstop 22 may be a strip of material attached to the end of legs 12. Backstop 22 may be of any suitable material including metals, rubber, or plastic. Additionally, backstop 22 may be formed as part of legs 12. In general, backstop 22 may be in the same plane as feet 12 and approximately parallel to the ground when handtruck 10 is in an upright position.

Leg locker 24 may act as a locking mechanism for legs 12. In particular embodiments, legs 12 may be movable with respect to back 14 of handtruck 10. Leg locker 24 provides one method for securing the placement of legs 12 with respect to back 14. In particular embodiments, leg locker 24 may be a lever that causes material to be pushed up against legs 12 preventing their movement. In other embodiments, legs 12 could be fitted with holes and instead of a lever. In such an embodiment, leg locker 24 could be a retractable rod that fits into the holes of legs 12 to keep legs 12 from moving. Regardless of the method of securing legs 12, leg locker 24 is operable to prevent the legs from moving once secured by leg locker 24.

Legs 12 are coupled to back 14. Back 14 may be generally perpendicular to legs 12 and provides a structure for payload lifter assembly 16 and potentially grips for moving handtruck 10. Payload lifter assembly 16 may be designed receive different payload couplers 26 or be designed to work with a specific payload. In particular embodiments payload lifter assembly 16 may raise and lower the payload by use of crank 28, screw 30, and pipes 32.

To raise or lower a payload, the payload may be attached to payload coupler 26. Crank 28 may be coupled to payload lifter assembly 16 through screw 30 through the threads of screw 30. By turning crank 28, screw 30 may rotate and cause payload lifter assembly 16 to be raised and lowered on back 14. Pipes 32 may encase a portion of back 14 allowing payload lifter assembly 16 to be raised and lowered along the plane of back 14. Although illustrated using a crank, a motor or other types of electrical or mechanical devices may be used to assist in raising or lowering the payload lifter assembly 16.

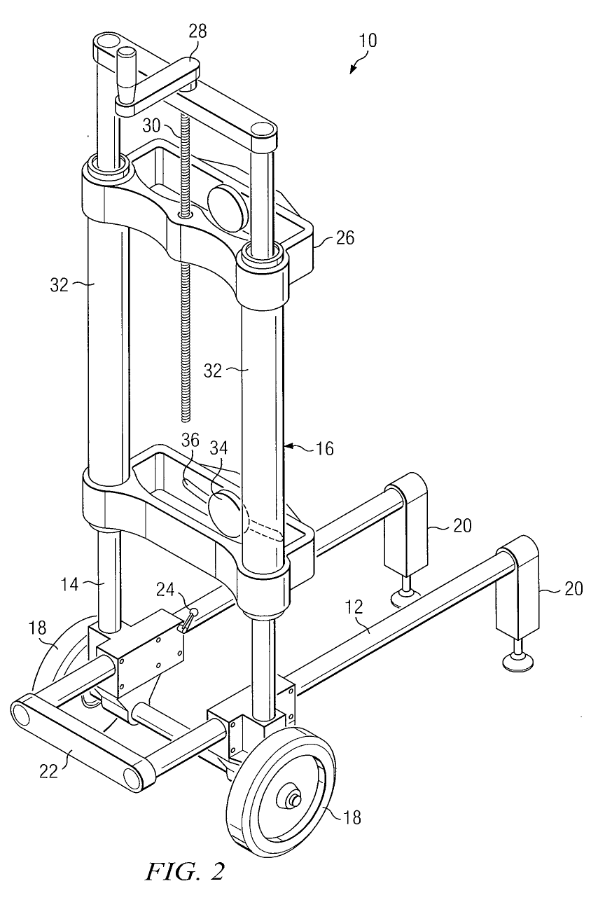

As another degree of movement, payload lifter assembly 16 may provide tilting of the payload. Knob 34 and groove 36 (not pictured) in particular embodiments may provide 15 degrees of tilt for the payload. In some embodiments, greater or lesser degrees of tilt may be utilized. This mechanism will be discussed in greater detail with respect to FIG. 2.

FIG. 2 is a reverse view of the multidimensional lifting handtruck of FIG. 1. This view more clearly illustrates knob 34 and groove 36. Knob 34 provides a securing mechanism for coupling payload lifter assembly 16 to payload coupler 26. Knob 34 may be secured to payload lifter coupler 26 by means of a screw type assembly or other suitable securing mechanism. By loosening knob 34 and moving knob 34 along groove 36, payload coupler 26 may tilt the payload up to fifteen degrees in either direction. Although fifteen degrees is described in this particular embodiment, other degrees of tilt could be used without departing from the spirit of the disclosure.

Moreover, FIG. 2 provides a better view of backstop 22. Backstop 22 provides a safety feature for handtruck 10. Often, in operation of handtruck 10, in order to move the payload from one place to another, handtruck 10 will be tilted backwards to prevent feet 20 from providing friction with the ground and allowing wheels 18 to roll smoothly. However, tilting of handtruck 10 backwards may cause handtruck to fall backwards potentially causing damage to the user, the payload and the handtruck itself. Backstop 22 provides an advantage of preventing handtruck 10 from falling backwards. In particular embodiments, backstop 22 is a piece of material that connects legs 12 with each other. In other embodiments, backstop 22 may be material that is part of legs. Moreover, the material for backstop 22 is not limited to any particular material or can be a combination of materials.

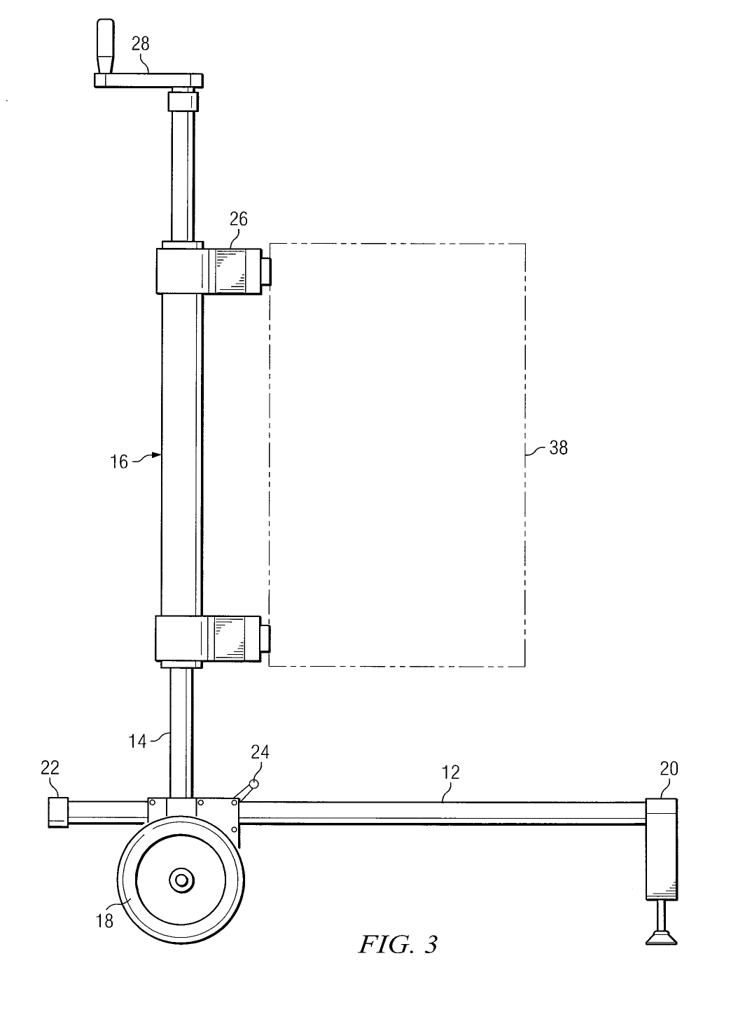

FIG. 3 illustrates the attachment of a payload to the multidimensional lifting handtruck in a particular embodiment. In general, payload 38 is any device or object that may need to be removed, installed, transported, or otherwise manipulated to, from, or at a location. In particular embodiments, payload 38 is secured to handtruck 10 via payload coupler 26. As previously described with respect to FIGS. 1 and 2, payload coupler 26 is coupled to payload lifter assembly 16 on back 14.

In the illustrated embodiment, payload 38 is secured to payload coupler 26 in two locations, one near the top of payload 38 and one near the bottom of payload 38. Securing payload 38 to payload coupler 26 may be accomplished using screws, clamps, belts or other appropriate devices. Payload coupler 26 may be specifically designed for a particular type of payload 38 and have a payload specific coupling mechanism.

In operation of handtruck 10 a user may couple a payload 38 to payload coupler 26. In order to couple payload 38 to payload coupler 26, the user may turn crank 28 to raise or lower payload lifter assembly 16 so that payload coupler 26 is aligned with the coupling points of payload 38. Additionally, the user may utilize knob 34 and groove 36 to better align payload 38 with payload coupler 26. Legs 12 may be moved forward or backwards and locked into place by using leg locker 24. Adjustment of feet 20 may also provide forward or backwards tilt to align payload 38 with payload coupler 26. Payload 38 may be secured in any appropriate fashion to handtruck 10.

After coupling payload 38 to handtruck 10, a user may tilt handtruck 10 backwards so that feet 20 are off the ground so that handtruck 10 may be supported by wheels 18. The user may then wheel handtruck 10 to a location where the payload is to be installed. Alternatively, the user may wheel handtruck 10 to a location where payload 38 is to be dropped off for replacement or further transport.

If a user is going to a location where payload 38 is to be installed, handtruck 10 may provide assistance to the user in the installation process. At an installation site with only one technician or in tight spaces, handtruck 10 may provide assistance to the user for installation of payload. For example, equipment is often installed on racks. It would be difficult for a single technician to lift equipment weighing 50-70 pounds and also provide stability while installing the equipment into a rack. By using the lifting and tilting features of handtruck 10, a single technician may be able to install the equipment without the assistance of another technician. Once payload 38 is at the installation site, the technician may use crank 28 to raise or lower payload 38 to the proper elevation on the rack. The technician may then adjust the height of feet 20 to achieve a forward or backwards tilt and adjust knob 34 to adjust a sideways tilt so that payload 38 may be positioned correctly into an installation rack. Once positioned, payload coupler 26 may continue to support payload 38 while the technician secures payload 38 into the rack. After securing payload 38 into its installation point, the technician may de-couple payload 38 from payload coupler 26, completing the installation of payload 38 at its desired location.

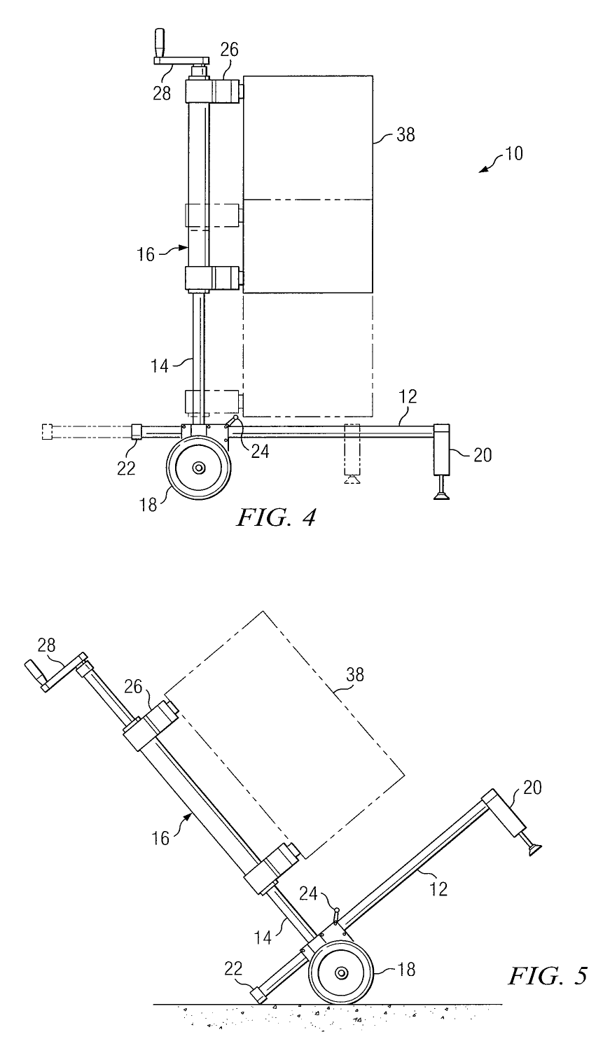

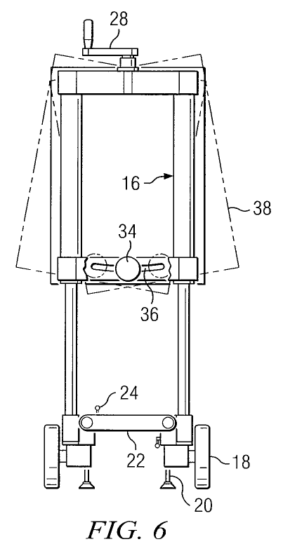

Although particular uses of handtruck 10 have been illustrated, additional uses will be readily apparent to those skilled in the art. For a more complete understanding of various features of handtruck 10 described above, FIG. 4 illustrates certain degrees of movement of handtruck 10. FIG. 5 illustrates the backstop feature. FIG. 6 illustrates the use of knob 34 in providing sideways tilt for handtruck 10.

FIG. 4 illustrates certain degrees of movement of the multidimensional lifting handtruck. In particular, FIG. 4 illustrates a lifting and lowering of payload 38 and the adjustment of the position of legs 12. In FIG. 4, payload 38 is illustrated at a higher position on handtruck 10. The phantom outline illustrates payload 38 in a lower position on handtruck 10. Although illustrated in two positions, payload 38 could be in any position between the higher and lower position and in certain embodiments be in higher or lower positions than those illustrated.

In particular embodiments, the position of legs 12 may also be adjusted. As illustrated in FIG. 4, the legs 12 are able to be moved perpendicularly with respect to back 14. In the illustrated embodiment, legs 12 are shown with feet 20 at a height as to have legs 12 substantially parallel to the ground. This position generally provides a stable position for handtruck 10. The phantom lines illustrate a position where legs 20 have been adjusted toward the rear of handtruck 10. Additionally, feet 20 have been adjusted toward legs 12. In this configuration, handtruck 10 would lean forward to achieve a stable position on flat ground.

FIG. 5 illustrates a backstop feature of particular embodiments of the multidimensional lifting handtruck. In this illustrated embodiment, handtruck 10 is shown tilted rearward as would generally be done to move payload 38 from one location to another. In general, particularly with heavy payloads 38, tilting of handtruck 10 rearward, may sometimes cause an operator to lose control of handtruck 10 and have it fall backwards to the ground. As illustrated in FIG. 5, backstop 22, provides a limit to the amount of rearward tilt of handtruck 10. This limited tilt also provides a stable position for handtruck 10 should an operator lose control of handtruck 10 in a backwards tilt position while moving payload 38. The amount of allowable tilt of handtruck 10 may be adjusted by the placement of legs 12.

FIG. 6 illustrates a tilting mechanism of particular embodiments of the multidimensional lifting handtruck. In this illustrated embodiment, knob 34 is shown in the middle of groove 36. In particular embodiments, this position would position payload 38 centered on handtruck 10. Knob 34 may then be moved along groove 36, thereby moving the anchor position of a portion of payload coupler 26 to provide a tilt to payload 38. As illustrated by the phantom lines, knob 34 may be moved to either side of groove 36 thereby tilting payload 38. In particular embodiments, payload 38 could be tilted fifteen degrees from the centered position. Providing additional or fewer degrees of tilt is considered within the scope of the disclosure.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A handtruck, comprising:
wheels;
legs that are coupled to the wheels, the legs approximately parallel to the ground when the handtruck is in an upright position, wherein the legs are operable to be moved within a plane that is approximately parallel to the ground;
a back, wherein the back is coupled approximately perpendicular to the legs; and
a payload coupler that is coupled to the back and operable to couple to a payload.

2. The handtruck of claim 1, further comprising a lifting mechanism for the payload coupler, the lifting mechanism comprising a crank and a screw.

3. The handtruck of claim 1, further comprising a lifting mechanism for the payload coupler comprising a motor.

4. The handtruck of claim 1, further comprising a backstop coupled to the legs and operable to prevent the handtruck from having the back be tilted into a plane approximately parallel to the ground.

5. The handtruck of claim 1, further comprising feet coupled perpendicularly to the legs.

6. The handtruck of claim 1, further comprising a tilting mechanism comprising a groove and a knob coupled to the payload coupler.

7. The handtruck of claim 6, further comprising a backstop coupled to the legs and operable to prevent the handtruck from having the back be tilted into a plane approximately parallel to the ground.

8. The handtruck of claim 6, further comprising a lifting mechanism for the payload coupler, the lifting mechanism comprising a crank and a screw.

9. A handtruck comprising:
wheels;
legs that are coupled to the wheels, the legs approximately parallel to the ground when the handtruck is in an upright position;
a back, wherein the back is coupled approximately perpendicular to the legs;
a payload coupler that is coupled to the back and operable to couple to a payload; and
a lifting mechanism that is operable to raise and lower the payload coupler along the back.

10. The handtruck of claim 9 wherein the legs are operable to be moved within a plane that is approximately parallel to the ground.

11. The hand truck of claim 9 wherein the lifting mechanism comprises a crank and a screw.

12. The handtruck of claim 9 wherein the lifting mechanism comprises a motor.

13. The handtruck of claim 9, further comprising a backstop coupled to the legs and operable to prevent the handtruck from having the back be tilted into a plane approximately parallel to the ground.

14. The handtruck of claim 9, further comprising feet coupled perpendicularly to the legs.

15. The handtruck of claim 9, further comprising a tilting mechanism comprising a groove and a knob coupled to the payload coupler.

16. The handtruck of claim 15, further comprising, a backstop coupled to the legs and operable to prevent the handtruck from having the back be tilted into a plane approximately parallel to the ground.

17. The handtruck of claim 15, further comprising, a lifting mechanism for the payload coupler, the lifting mechanism comprising a crank and a screw.

18. A handtruck comprising:
wheels;
legs that are coupled to the wheels, the legs approximately parallel to the ground when the handtruck is in an upright position, wherein the legs are operable to be moved within a plane that is approximately parallel to the ground;
a backstop coupled to the legs and operable to prevent the handtruck from having the back be tilted into a plane approximately parallel to the ground;
a back, wherein the back is coupled approximately perpendicular to the legs;
a payload coupler that is coupled to the back and operable to couple to a payload;
a lifting mechanism that is operable to raise and lower the payload coupler along the back; and
a tilting mechanism comprising a groove and a knob coupled to the payload coupler.

19. The handtruck of claim 18 wherein the lifting mechanism comprises a crank and a screw.

20. The handtruck of claim 18, further comprising feet coupled perpendicularly to the legs.
